(19) United States
(12) Patent Application Publication
(10) Pub. No.: US 2006/0051462 A1
(43) Pub. Date: Mar. 9, 2006

(54) Self emulsifying compositions for delivering lipophilic coenzyme Q10 and other dietary ingredients

(76) Inventor: Jimmy X. Wang, Great Neck, NY (US)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/217,867

(22) Filed: Sep. 1, 2005

Related U.S. Application Data
(60) Provisional application No. 60/607,320, filed on Sep. 3, 2004.

(51) Int. Cl. A23L 1/30

(52) U.S. Cl. 426/72

(57) ABSTRACT

The present invention provides novel dietary supplement compositions based on the use of a particular oil phase which comprises of Coenzyme Q10 and optionally other lipophilic dietary ingredients of low water solubility and a liquid mixture which comprises one or more emulsifiers, a fatty acid monoester formed between an short chain alcohol of C1 to C4 chain length and a saturated, or mono-unsaturated, or di-unsaturated (both conjugated and non-conjugated) fatty acid of C6 to C24 chain length, or medium chain mono-/di-esters, or the mixture of above. The composition is in a form of self-emulsifiable in the aqueous medium, for example, a simulated gastric fluid, which should provide a high oral bioavailability for the lipophilic dietary ingredients.

This application claims benefit of U.S. Ser. No. 60/607,320, Filed Sep. 3, 2004, the content of which is incorporated into this application by reference.

Throughout this application, various publications are referenced. Disclosures of these publications in their entireties are hereby incorporated by reference into this application in order to more fully describe the state of the art to which this invention pertains.

### FIELD OF THE INVENTION

The present invention relates to liquid compositions suitable for orally administration, and in particular to such compositions that are capable of self emulsification in an aqueous medium, for example, the simulated gastric fluid.

### BACKGROUND OF THE INVENTION

As defined by Congress in the Dietary Supplement Health and Education Act (http://www.fda.gov/opacom/laws/dshea.html#sec3), which became law in 1994, a dietary supplement is a product that (a) is intended to supplement the diet; (b) contains one or more dietary ingredients (including vitamins, minerals, herbs or other botanicals, amino acids, and other substances) or their constituents; (c) is intended to be taken by mouth as a pill, capsule, tablet, or liquid, and (d) is labeled on the front panel as being a dietary supplement.

The use of dietary supplement is well known. For example, coenzyme Q10 is a vitamin-like substance used around the world to treat congestive heart failure and other cardiac problems. One of the difficulties encountered in formulated such supplements for human ingestion is that many of the supplements are lipophilic and poorly water soluble. Since the human digestive tract is a substantially aqueous system, it is difficult to provide the supplement products with the use of conventional formulation technologies (e.g., tablets, powder in capsules, suspensions) that will dissolve readily in the digestive tract for absorption. Therefore, the bioavailability of the lipophilic, poorly soluble dietary ingredients from these products using conventional formulation technologies is commonly reported to be extremely low.

Coenzyme Q10 (CAS registry number 303-98-0), also known as ubiquinone 10, or ubidecarenone, or neuquinone, and referred as to CoQ10 in the following text, is a lipophilic dietary ingredient with extremely low water solubility. It is an antioxidant that plays a critical role in cellular mitochondrial generation of energy, stimulates the immune system, increases circulation and strengthens the cardiovascular system. Deficiencies in CoQ10 have been linked to several debilitating diseases. Current research, and clinical trials around the world are substantiating these and further claims, including periodontal disease, diabetes, asthma, allergies and other respiratory diseases, mental and psychological diseases, cancer, Alzheimer's disease, multiple sclerosis, muscular dystrophy, male impotency and diabetes. It is also being used to reduce side effects of cancer chemotherapy and the treatment of degenerative heart diseases.

CoQ10 is a class of physiological substances occurring as component factors of the mitochondrial electron transfer system within the biological cell. CoQ10 acts directly as an electron carrier in oxidative phosphorylation reactions, through metabolic pathways, particularly aerobic pathways, to produce ATP and hence energy. It seems that the demand for CoQ10 is increased in normal subjects in the state of physical fatigue and patients with cardiovascular disease, chronic debilitating disease or on prolonged pharmacotherapy. As a result it may be a sound therapeutic choice to administer CoQ10 to patients suffering from such problems.

The amount of CoQ10 in the body decreases with age. Although it is available in our diet through beef, eggs, fish and organ meats, our assimilation of CoQ10 becomes more difficult with age. As a result, its use as a dietary ingredient has increased dramatically in the last decade.

In order for CoQ10 to provide its therapeutic effect, the concentration of CoQ10 must increase within the patient's cells. As a result, absorption into the blood stream as well as into the cells themselves is critical. CoQ10 has a molecular weight of 864. Because of its size and structure, it is very lipophilic, practically insoluble in water, and soluble in a limited number of oils. Additionally, it is readily recognized that CoQ10 is very insoluble in normal human/animal digestive fluids, thereby resulting in its poor bioavailability from oral dosage forms. Because of its high molecular weight and lipophilic nature, this molecule is poorly absorbed into the intestinal tract.

Therefore, any technology that markedly enhances uptake of CoQ10 represents a significant advance in the delivery of this molecule to the human body since CoQ10 is a good general representation of the class of large, high molecular weight dietary ingredients, any technology that results in its enhanced bioavailability has application to other dietary ingredients in this class.

A variety of methods have been investigated to reduce the dosage quantities and/or the dosage frequency of CoQ10. Perhaps the oldest methods involve the administration of such therapeutic agents in oily preparations, for example dissolving the dietary ingredient in natural oils, such as castor oil, or as mixtures of such oils with high molecular weight polyols such as polyglycerol. A preparation of this type is described in U.S. Pat. No. 4,156,718, but such preparations are unpleasant to administer because of their odor and taste, as well as the fact that many lipophilic dietary ingredients have an undesirable and/or bitter taste themselves. Additionally, such oily preparations have a tendency to coat the mouth and thereby further reduce patient compliance and inhibit consumption of such preparations. Furthermore, because such formulations are not readily broken down by the digestive system, the CoQ10 dissolved in these formulations tends to pass through the digestive system without being released from the oleaginous matrix in which it is ingested. Therefore the bioavailability of the dietary ingredient is not significantly improved by its incorporation into such a matrix.

The administration of CoQ10 in soybean oil via oral administration was disclosed by K. Folkers and K. Muratsu (Biomedical and Clinical Aspects of Coenzyme Q, Volume 3, K. Folkers and Y. Yamamura eds., Elsevier/North-Holland Biomedical Press, Amsterdam, 31-42, 1981). That publication described a soft gel capsule containing 33.3 mg of CoQ10 in about 400 mg of soybean oil. This method represented some improvement in the oral delivery of CoQ10, but it suffered from problems with long-term shelf life because the CoQ10 would crystallize out of the soybean oil, thereby limiting the bioavailability of this dietary ingredient.

An early use of a neutral oil to dissolve the CoQ10 is found in U.S. Pat. No. 4,824,669, which describes the formation of a stable emulsion capable of delivering CoQ10 to the human body by intravenous administration. The vehicles for intravenous administration were soybean, corn, peanut, safflower, or olive oil emulsions into which the CoQ10 was dissolved. This method improves delivery of CoQ10 to the body, but it is confined to the intravenous administration of this large, high molecular weight, lipophilic, dietary ingredient agent.

In addition to solutions of CoQ10 in oils and high molecular weight glycerols, clear micellized solutions have been employed to deliver CoQ10. U.S. Pat. No. 4,572,915 describes a method for producing such clear, micellar solutions of fat soluble vitamins and essential nutrients that permit enhanced absorption of those vitamins and nutrients. Specifically, this patent describes a method for delivering vitamins such as fat soluble vitamins (such as Vitamins A, E, D, and/or derivatives), essential nutrients, non-water soluble dietary ingredients and active pharmaceutical agents, in a mixture of polyethoxylated castor oil (such as the 30 and 40 mole ethoxylated castor oils) and a nutraceutically acceptable polyol (such as glycerol or diethylene glycol) which when heated above 55° C. in either the presence of (or absence) of water forms a uniform homogeneous mixture that can be diluted with water.

A more recent formulation technology involves the mixture of dietary ingredient into solid lipophilic oral dosage forms. This method, as described in U.S. Pat. No. 5,989,583, involves mixing at least one solid fat and a phospholipid with the dietary ingredient. The mixture is then delivered to the organism in an appropriate dosage form such as a gelatin capsule, a tablet, or even a beverage. Specifically, the fat described in this patent is either a triglyceride or mixture of triglycerides, and the phospbolipid is lecithin. The dietary ingredient, triglyceride, phospholipid and an antioxidant are dissolved in a solvent such as dichloromethane. The solvent is evaporated to complete dryness and the lipid mixture is then hydrated with water by mechanical shaking. The resultant lipid dispersion is then homogenized with a high-pressure homogenizer to reduce the particle size to the submicron range. This dietary ingredient-lipid preparation is then mixed with a cryoprotectant such as sucrose and a flow-imparting agent, freeze-dried, and placed in capsules. This type of formulation, which involves multiple steps and solvents and must be handled carefully because of environmental concerns, is no longer economically feasible. Additionally, the enhanced bioavailability achieved is only moderate, especially in view of the expense involved and the complexity of the formulation.

An alternative method involves a formulation containing the dietary ingredient in a matrix containing a solubilizing agent and an edible polyhydric alcohol to create a liquid formulation that is encapsulated in a gelatin capsule as set out in U.S. Pat. No. 6,056,971. The bioavailability of the CoQ10 from this formulation was said to be greater than a formulation of the CoQ10 dissolved in a standard vegetable oil vehicle (the “reference” CoQ10 capsules). The difficulty with this type of formulation is that it is composed of almost 90% solubilizing agent that is selected from a group of non-ionic surface-active agents. As long as food grade materials are used in the formulation, these materials are not generally considered to be harmful when ingested. However, the ingestion of the amount of surface-active agents needed to achieve enhanced CoQ10 bioavailability can show side-effects such as softening stools and/or causing diarrhea. Additionally, for the reasons described above, it is not difficult to demonstrate enhanced bioavailability of a formulation compared to the bioavailability of the same large, high molecular weight, lipophilic dietary ingredient dissolved in a standard vegetable oil since the delivery of such agents from the latter matrix is extremely poor.

An alternative method as described in U.S. Pat. No. 6,191,172 involves a formulation containing a dietary ingredient and a solubilizing agent created by chemically combining a tocopherol or sterol derivative (such as a sebecate) with high molecular weight polyethylene glycol or methoxypolyethylene glycol. Although no data is presented to demonstrate the enhanced bioavailability of CoQ10 from this formulation, the bioavailability of the patented technology was compared to that of CoQ10 in an oil formulation. As discussed above, it is not difficult to demonstrate enhanced bioavailability of a formulation compared to the bioavailability of the same large, high molecular weight, lipophilic dietary ingredient dissolved in a standard vegetable oil because the delivery of dietary ingredient from the latter matrix is poor. Additionally, the patent describes toxicity issues with one of the chemically combined tocopherol-polyethylene glycol-sebecate solubilizing compounds. Since this derivative is the commercially available molecule, there is an indication that this technology needs significantly more research effort before it can be considered to be a commercially viable method for enhancing the bioavailability of large, high molecular weight, lipophilic dietary ingredient.

U.S. Pat. No. 6,184,255 describes a novel way of improving the bioavailability of CoQ10 by administering a combination of the oxidized and reduced forms of this dietary ingredient. This patent teaches that the bioavailability of the agent is less dependent upon the medium in which the agent is delivered, but more importantly, is dependent upon the oxidation state of the agent. Although this may be true, the ability to obtain and stabilize a mixture of the oxidized (Ubiquinone) and reduced (Ubiquionol) forms of CoQ10 is significantly more difficult than is apparent.

Low bioavailability of lipophilic dietary ingredients with extremely low water solubility can be a serious problem. Different approaches have been taken to achieve a desired level of dietary ingredient solubility and dissolution rate. These approaches have been based on preparations with increased surface area (micronised powders), molecular inclusion complexes (cyclodextrines and derivatives), co-precipitates with water-soluble polymers (PEG, PVP, HPMC) and non-electrolytes (urea, mannitol, sugars etc.), synthetic emulsifier micellar solutions (Cremophor®, Tween®, Gellucires®, VE-TPGS 1000, etc.), and multilayer vesicles (liposomes and niosomes). Dispersed colloidal vehicles, such as oil-in-water, water-in-oil and multiple (O/W/O or W/O/W) emulsions, microemulsions and self-emulsifying compositions also have been used to improve bioavailability of poorly soluble substances.

Self-emulsifying delivery systems usually comprise a mixture of the liquid or semi-solid lipid phase (e.g., fatty acids, fatty acid glycerides or esters, etc.) with one or more synthetic emulsifiers (e.g., polysorbate 80), and an additional cosolvent (e.g., short chain aliphatic alcohols). A lipophilic dietary ingredient can be efficiently dissolved in the mixture. After the addition of water, the mixture rapidly converts into an oil-in-water emulsion with the dietary ingredient remaining in the oil droplets. Absorption of the dietary ingredient in gastro-intestinal system from the emulsion is increased.

Microemulsion systems are to some extent similar to a self-emulsifying system and often are composed of analogous components (lipid, synthetic emulsifier, and short or medium chain alcohol) with the difference being in the ratio of the components. When diluted with water, an oil-in-water or water-in-oil emulsion may be produced, accordingly to composition and water amount. Dietary ingredient entrapment and distribution in the stomach and intestine is also good.

All of the delivery systems discussed are liquid preparations and as such, the formulation must be administered as a fluid mixture or as a soft gelatin capsule (SGC) or a hard shell capsule comprising of gelatin or HPMC polymer.

In the prior art, namely U.S. Pat. No. 5,897,876, issued Apr. 27, 1999 to Rudnic et al., there is disclosed an emulsified dietary ingredient delivery system which specifically relates to a water-in-oil emulsion which contains a discontinuous water phase in an amount of between 5.1 and 9.9%.

In terms of other advancements in this field, U.S. Pat. No. 6,174,547, issued Jan. 16, 2001, to Dong et al. teaches a liquid composition comprising a hydrophilic phase retained in a osmotic hydrogel matrix. This reference is primarily focused on a two phase emulsion. This is a significant departure from an emulsifiable composition. The composition set forth in the reference is not emulsifiable, since the composition is already emulsified in its liquid form. In this manner, Dong et al. do not address the complications associated with providing a homogeneous distribution within a tablet, which composition can be emulsified under certain conditions.

In Friedman et al., U.S. Pat. No. 6,004,566, issued December 1999, there is disclosed a topical emulsion cream. The emulsion is designed for transdermal delivery. Friedman et al. is only relevant to emulsions; there is nothing in the reference which would provide one skilled in the art with instruction to form a tableted emulsifiable composition.

In Chopra U.S. Pat. No. 6,441,050 B1, issued Aug. 27, 2002, there is disclosed a palatable oral liquid (syrup) composition. The liquid comprises of CoQ10 and a major amount of a vegetable oil or triglycerides. There is nothing in the reference which would provide one skilled in the art with instruction to form a self-emulsifiable composition.

In Supersaxo et al. U.S. Pat. Application No. 2004/0152612 A1 published Aug. 5, 2004, there are disclosed oral liquid compositions comprising of CoQ10, one or more surfactants, medium chain triglycerides and either omega-9 or omega-6 fatty acids. This teaches the formulation of microemulsions and disclosed improved oral bioavailability in humans by the use of such formulations. However, there is nothing in the reference which would provide one skilled in the art with instruction to use mono- and di-esters of fatty acids in a self-emulsifiable composition.

### SUMMARY OF THE INVENTION

One object of the present invention is to provide a dietary supplement composition comprising CoQ10 and optionally one or more other lipophilic dietary ingredients. A further object of the present invention is to provide a dietary supplement composition containing a high load of the lipophilic dietary ingredients for convenient oral administration and to provide high oral bioavailability.

Another object of the present invention is to provide commercial viable CoQ10 products, which exhibit adequate physical and chemical stability in a self-emulsifying formulation.

Still another object of the present invention is to provide a liquid composition for encapsulation into either soft elastic capsules or hard shell capsules.

The objects of the present invention have been accomplished in that the present invention provides nutriceutical compositions in a self-emulsifying formulation which allows a high loading of the total lipophilic dietary ingredients (add up to about 500 mg/g) while at the same time achieving good oral bioavailability.

The present invention specifically provides dietary supplement compositions based on the use of a particular oil phase, which comprises:
(a) CoQ10 and optionally one or more other lipophilic dietary ingredients,
(b) one or more nutraceutically acceptable lipids, and
(d) one or more nutraceutically acceptable emulsifiers.

Compositions of the invention have been found to resolve at least some of the difficulties alluded to above in a surprisingly effective manner. Thus, according to the present invention, a composition comprising CoQ10, a lipophilic dietary ingredient of low water solubility, that is completely dissolved in a solution formulation is now presented, optionally in an encapsulated dose form suitable for oral administration, such that the composition is self emulsifiable in simulated gastric fluid. Particular advantages of compositions of the invention are that they are suitable for encapsulation and, following oral administration thereof, they permit rapid absorption of CoQ10 into the bloodstream through formation of emulsions upon exposure to aqueous media, for example, the aqueous environment of the gastrointestinal tract.

This invention provides an orally deliverable dietary supplement composition comprising: (a) CoQ10 and optionally one or more other lipophilic, poorly soluble dietary ingredients; (b) a mixture consisting essentially of one or more monoesters of a long chain fatty acid having C6 to C24 carbon chain length and a short chain alcohol having C1 to C4 carbon chain length or one or more medium chain mono- and di-esters or a combination thereof; and (c) one or more emulsifier, wherein in the composition CoQ10 is completely dissolved and a substantial portion or the whole amount of the other dietary ingredients are in dissolved form, and wherein the fatty acid ester and the emulsifier are present in relative amounts such that the composition is self emulsifiable in the human biological fluids (e.g., gastric fluid).

In an embodiment, the dietary ingredients are selected from the group consisting of CoQ-10 or Ubiquinone, Vitamin A, Vitamin D, Beta Carotene, Mixed Carotenoids Complex, Tocotrieniols, Tocopherols (or Vitamin E), Ascorbyl Palmitate, Soy Isoflavones, Lecithin, Lutein, Lycopene, Zeaxanthin, Beta-Cryptoxanthin, Resveratrol, Red Clover, and Saw Palmetto Lipid Extract. In another embodiment, the composition may optionally comprise one or more other dietary ingredients at an amount of about 1 mg to about 1000 mg of all dietary ingredients in combination. In a further embodiment, the other dietary ingredients are at an amount of about 50 to about 500 mg. In a still further embodiment, it is 100 to 300 mg. In another embodiment, it is at 1 to 500 mg. In a still further embodiment, it is at about 1 to 250 mg.

In a separate embodiment, the fatty acid monoester is chemically formed between a short chain (C4 or less than) alcohol and a fatty acid. In a further embodiment, the short chain alcohol component of the fatty acid monoester is ethanol or methanol. In a further embodiment, the fatty acid component of the fatty acid monoester comprises a saturated or unsaturated C6 to C24 carbon chain. In a further embodiment, the fatty acid is octanoic acid, caproic acid, caprylic acid, capric acid, lauric acid, myristic acid, palmitic acid, stearic acid, hydroxysteric acid, icosteric acid, elaidic acid, behenic acid, arachidic acid, palmitoleic acid, oleic acid, ricinoleic acid, linoleic acid, linolenic acid, eicosapentanenoic acid, erucic acid, and/or docosahexaenoic acid. The preferred monoesters are ethyl oleate, ethyl ester of conjugated linoleic acid (ECLA) and ethyl ester of conjugated linolenic acid (ECLN).

In a further embodiment, the medium chain mono- and di-esters are propylene glycol diesters, preferably Captex@100 and Captex® 200 (Abitec), or medium chain mono-/di-glycerides Capmul® MCM (Abitec) or a combination thereof.

In a further embodiment, the emulsifier is polysorbates (Polysorbate 80, 20, 60, 65; Croda), lecithin, Solutol (BASF), HS-15 (BASF), Cremophor® EL or RH40 (BASF), VE TPGS 1000 (Eastman Kodak), or sodium docusate. In a further embodiment, the emulsifier is polysorbate 80 or lecithin. In a further embodiment, the emulsifier is polysorbate 80 in an amount of about 1% to about 50% weight per weight of the liquid vehicle, in an amount of 5% to 35%, or 5 to 20%.

This invention provides a composition as described above further comprising an additional emulsifier. In an embodiment, the additional emulsifier is lecithin in an amount of about 5% to about 50% weight per weight of the liquid vehicle, in an amount of 10% to 40%, or in 15 to 30%. In another embodiment, the fatty acid ester and the emulsifiers are collectively present in an amount of about 10% to about 95%, by weight of the composition. In a further embodiment, the dietary ingredients present in the composition are completely dissolved in the liquid vehicle.

In a further embodiment, the solvent liquid further comprises one or more nutraceutically acceptable excipients selected from sweeteners, antioxidants, preservatives, flavoring agents, colorants, and thickeners.

This invention provides a composition as described above wherein CoQ10 in the composition is in dissolved form, and the composition may optionally comprise one or more dietary ingredients that may be partially dissolved in the vehicle and the rest portion is in particulate form dispersed. In an embodiment, the composition comprises at least about 6% by weight of CoQ10.

This invention provides a composition as described above in the form of an unencapsulated imbibable liquid. In an embodiment, the unencapsulated imbibable liquid is administered orally by dilution with appropriate diluents and a dilution procedure.

This invention provides a composition as described comprising one or more discrete dose units for oral administration, wherein a suitable amount of the dietary ingredient is contained in one to a small plurality of said dose units. In an embodiment, each dose unit is surrounded by a wall to form a liquid-filled capsule and the capsule shell material is gelatin. In another embodiment, the capsule shell material is a polymer, which comprises hydroxypropyl methylcellulose (HPMC).

### DETAILED DESCRIPTION OF THE INVENTION

Dietary Ingredient of Low Water Solubility

Novel dietary supplement compositions according to the present invention comprise one or more orally deliverable dose units. The term “orally deliverable” herein means suitable for oral administration. The term “dose unit” herein means a portion of a dietary supplement composition that contains an amount of a dietary ingredient, in the present case a lipophilic dietary ingredient of low water solubility, suitable for a single oral administration to provide a therapeutic effect. Typically one dose unit, or a small plurality (up to about 4) of dose units, provides a sufficient amount of the agent to result in the desired effect. The term “oral administration” herein includes any form of delivery of a dietary ingredient or a dietary supplement composition thereof to a subject wherein the agent or composition is placed in the mouth of the subject, whether or not the agent or composition is swallowed. Thus “oral administration” includes buccal and sublingual as well as esophageal administration. Absorption of the agent can occur in any part or parts of the gastrointestinal tract including the mouth, esophagus, stomach, duodenum, ileum and colon.

Each dose unit comprises a dietary ingredient of low water solubility in a biologically effective total amount. The term “dietary ingredient of low water solubility” as used herein, refers to any dietary ingredient or compound with a solubility in water, measured at 37° C., not greater than about 10 mg of dietary ingredient per ml of water, and preferably not greater than about 1 mg of dietary ingredient per ml of water. The invention can be practiced with a wide variety of dietary ingredients of low water solubility. Suitable dietary ingredients include, without limitation, from the following classes and combinations thereof.

Suitable dietary ingredients of low water solubility and high lipophilicity include, for example, micronutrients such as vitamins, minerals, and other nutritional co-factors. Exemplary agents include, but are not limited to, CoQ-10 (Ubiquinone), Soy Isoflavones, Zeaxanthin, Beta-Cryptoxanthin, Red Clover, Beta Carotene, Mixed Carotenoids Complex, Lutein, Lycopene, Lecithin, Tocotrieniols, Tocopherols (Vitamin E), Saw Palmetto Lipid Extract, Ascorbyl Palmitate, and mixtures thereof.

In a particularly preferred embodiment, the dietary ingredient is a CoQ10 with an amount of about 10 mg to about 200 mg per dose unit.

This invention provides a composition as described above wherein CoQ10 in the composition is in dissolved form, and the composition may optionally comprise one or more dietary ingredients that may be partially dissolved in the vehicle and the rest portion is in particulate form dispersed. In an embodiment, the composition comprises at least about 6% by weight of CoQ10. In a further embodiment, the composition comprises at least 10%. In a still further embodiment, it comprises at least 20%. In another embodiment, it comprises at least 30%.

The term “self-emulsifying formulation” used herein refers to a concentrated composition capable of generating emulsions or microemulsions upon mixing with sufficient aqueous media.

The emulsions or microemulsions generated from the present invention are comprising a hydrophilic phase and a lipophilic phase. The term “self-emulsifying formulation vehicle” refers to a composition comprising a mixture of fatty acid monoester, with the unsaturated fatty acid having sixteen to twenty-two carbon chain length, medium chain (C6 to C12) monoglycerides and diglycerids, and one or more nutraceutically acceptable emulsifiers. Optionally, the self-emulsifying formulation vehicle may further comprise a basic amine and a solvent.

Compositions of the present invention are preferably in the form which may or may not be encapsulated as a discrete article. Alternatively, compositions of the present invention are in the form of an imbibable liquid. The phrase “imbibable liquid” is used herein to refer to an unencapsulated, substantially homogeneous flowable mass, such as a solution or solution/suspension, administered orally and swallowed in liquid form and from which single dose units are measurably removable. The term “substantially homogeneous” with reference to a dietary supplement composition that comprises several components means that the components are sufficiently mixed such that individual components are not present as discrete layers and do not form concentration gradients within the composition.

Form of Compositions of the Invention

Compositions of the dietary supplement of the present invention comprise a dietary ingredient of low water solubility in a liquid vehicle suitable for oral administration.

The term “excipient” herein means any substance that is used as a carrier or vehicle for delivery of a dietary ingredient to a subject or added to a dietary supplement composition to improve its handling, storage, dispersion, dissolution, release properties or to permit or facilitate formation of a dose unit of the composition into a discrete article such as a capsule suitable for oral administration. Excipients can include, by way of illustration and not limitation, co-solvents, flavors, dyes, fragrances, preservatives, antioxidants, diluents, polymers, substances added to mask or counteract a disagreeable taste or odor, substances added to improve appearance of the composition and other functional substances such as effervescent agents and absorption enhancers added to improve the absorption.

Such excipients should be physically and chemically compatible with the other ingredients of the composition and should not be deleterious to the recipient. Importantly, some of the above-listed classes of excipients overlap each other. Compositions of the present invention can be adapted for administration by any suitable oral route by selection of appropriate solvent liquid components and a dosage of the dietary ingredient effective for the treatment intended.

An imbibable composition of the invention can be in the form of, for example, a solution, a solution/suspension, an elixir, a syrup, or any other liquid form reasonably adapted for oral administration. Such compositions can also comprise excipients selected from, for example, wetting agents, emulsifying and suspending agents, sweetening and flavoring agents.

Alternatively, a composition of the present invention can be in the form of discrete unit dose articles, for example capsules, each containing a predetermined amount of dietary ingredient in a liquid vehicle. Unexpectedly, we have now discovered that a polyether- or polyester comprising polymer, when present as a component of a capsule wall surrounding a solution or solution/suspension of the invention, can inhibit crystallization of the dietary ingredient upon exposure to simulated gastrointestinal fluid. Therefore, as is described in detail below, where a composition of the invention is encapsulated, it is preferably encapsulated in a wall comprising a polyether- or polyester comprising polymer.

Concentrated Solutions of the Invention

A preferred embodiment of the present invention is a composition comprising an appreciate amount of CoQ10 and optionally other lipophilic dietary ingredients in which CoQ10 is completely dissolved. In this embodiment, the other dietary ingredients may be completely dissolved or partially dissolved with particulate suspended in the liquid vehicle. Compositions of this embodiment can be formulated either in an imbibable or discrete (e.g. encapsulated) dosage form. Preferably, concentrated solutions of this embodiment have a total dietary ingredient concentration of about 1% to about 90%, preferably about 5% to about 75%, and more preferably about 5% to about 35%, by weight of the composition.

Dietary supplement compositions of the invention comprise one or more nutraceutically acceptable fatty acid esters and one or more nutraceutically acceptable emulsifiers in absolute and relative amounts such that the compositions are self micro-emulsifiable in simulated gastric fluid. Without being bound by theory, it is believed that a collective effect of the fatty acid esters and the emulsifier imparts self emulsifying characteristics in compositions of the invention by promoting formation of fine emulsion droplets upon exposure of the composition to the aqueous media.

Lipids

Liquid vehicles in compositions of the invention can additionally comprise any nutraceutically acceptable excipient. Components employed in the liquid vehicle can themselves be solids, semi-solids, liquids, or combinations thereof.

Compositions of the present invention comprise one or more nutraceutically acceptable lipids. Non-limiting examples of fatty acid ester of the invention include the ethyl esters and methanol esters of the preferred fatty acids including oleic acid, octanoic acid, lactic acid, caproic acid, caprylic acid, capric acid, lauric acid, myristic acid, palmitic acid, stearic acid, icosanoic acid, elaidic acid, conjugated and non-conjugated linoleic acid, conjugated and non-conjugated linolenic acid, alpha-linolenic acid, eicosapentaeoic acid, and docosahexaenoic acid. The ethyl esters of oleic acid (ethyl oleate), linoleic acid (ethyl linoleate), conjugated linoleic acid (ECLA), linolenic acid (ethyl linolenate) linolenic acid (ECLN), and octanoic acid (ethyl octanoate) are preferred.

Non-limiting examples of lipids optionally for use in compositions of the present invention include other type of esters with the medium chain fatty acids and long-chain fatty acids. For example, medium chain propylene glycol diesters (Captex® 100, 200 from Abitec), medium chain caprylic/capric mono- and diglycerides, for example Capmul® MCM (Abitec); polyoxyethylene caprylic/capric glycerides such as polyoxyethylene (8) caprylic/capric mono- and diglycerides, for example Labrasol™ of Gattefossé; propylene glycol fatty acid esters, for example propylene glycol laurate. oleic and linoleic acid triglycerides. Captex 100, 200 and Capmul MCM are also preferred fatty acid esters.

Preferred fatty acids have a saturated or unsaturated C₆ to C₂₄ carbon chain. Non-limiting examples of fatty acids that can be used in compositions of the invention include oleic acid, octanoic acid, lactic acid, caproic acid, caprylic acid, capric acid, lauric acid, myristic acid, palmitic acid, palmitoleic acid, stearic acid, icosanoic acid, elaidic acid both conjugated and non-conjugated linoleic acid (, alpha-linolenic acid, gamma-linolenic acid, both conjugated and non-conjugated linolenic acid, eicosapentaeoic acid, and docosahexaenoic acid. Among the list provided above, oleic acid, conjugated linoleic acid, conjugated linolenic acid and octanoic acid are the most preferred fatty acids.

Emulsifying Agents

Liquid vehicles of the present invention comprise one or more nutraceutically acceptable emulsifying agents or emulsifiers. Non-limiting examples of emulsifiers that can be used in compositions of the present invention include lecithin, polysorbate 20, polysorbate 40, polysorbate 60, polysorbate 80 (e.g., Tween™ 80 of ICI), polyoxyethylene (35) castor oil (BASF), polyoxyethylene (20) cetostearyl ether, polyoxyethylene (40) hydrogenated castor oil (BASF), polyoxyethylene (10) oleyl ether, polyoxyethylene (40) stearate, propylene glycol laurate (e.g., Lauroglycol™ of Gattefossé), VE-TPGS 1000 (Eastman Kodak), dioctyl sodium sulfosuccinate (or sodium docusate), poloxamers, polyoxyethylene (8) caprylic/capric mono- and diglycerides (e.g., Labrasol™ of Gattefossé), sodium lauryl sulfate, sorbitan monolaurate, sorbitan monooleate, sorbitan monopalmitate, sorbitan monostearate, tyloxapol, and mixtures thereof. Polysorbate 80 and lecithin are preferred emulsifiers.

Other Excipients

Compositions of this embodiment optionally contain nutraceutically acceptable excipients other than solvents and polyether- or polyester-comprising polymers, for example co-solvents, wetting agents, sweeteners, antioxidants, dispersants, preservatives, etc. Through selection and combination of excipients, compositions can be provided exhibiting improved performance with respect to solvent liquid concentration, dissolution, dispersion, efficacy, flavor and overall patient compliance.

Sweeteners

Compositions of the present invention optionally comprise one or more nutraceutically acceptable sweeteners. Non-limiting examples of sweeteners that can be used include mannitol, propylene glycol, sodium saccharin, acesulfame K, neotame and aspartame. Alternatively or in addition, a viscous sweetener such as sorbitol solution, syrup (sucrose solution) or high-fructose corn syrup can be used and, in addition to sweetening effects, can also be useful to increase viscosity and to retard sedimentation.

Preservatives

Compositions of the present invention optionally comprise one or more nutraceutically acceptable preservatives. Non-limiting examples of such preservatives include benzoic acid, sodium benzoate, benzethonium chloride, benzyl alcohol, chlorobutanol, phenol, phenylethyl alcohol, methylparaben, propylparaben, etc.

Antioxidants

Compositions of the present invention optionally comprise one or more nutraceutically acceptable antioxidants. Non-limiting illustrative examples of suitable antioxidants include α-tocopherol, ascorbic acid, ascorbic acid palmitate, butylated hydroxyanisole (BHA), butylated hydroxytoluene (BHT), fumaric acid, hypophosphorous acid, malic acid, alkyl gallates, for example propyl gallate, lauryl gallate, or octyl gallate, sodium ascorbate, sodium metabisulfite, sodium sulfite, sodium bisulfite and vitamin E. Preferably, the antioxidant is a free radical-scavenging antioxidant. More preferably the antioxidant is selected from alkyl gallates, vitamin E, BHA and BHT. Most preferably the free-radical scavenging antioxidant is propyl gallate. One or more antioxidants, if desired, are present in compositions of the invention in an amount of about 0.01% to about 2.5%, preferably about 0.01% to about 1%, and more preferably about 0.01% to about 0.5%, by weight of the liquid vehicle.

Additional Excipients

Additionally, compositions of the present invention optionally comprise one or more nutraceutically acceptable flavoring agents, colorants, stabilizers and/or thickeners. Flavoring agents can enhance patient compliance by making the composition more palatable, and colorants can provide a product with a more aesthetic and/or distinctive appearance. Non-limiting examples of colorants that can be used in compositions of the present invention include D&C Red No. 33, FD&C Red No. 3, FD&C Red No. 40, D&C Yellow No. 10, and C Yellow No. 6.

Discrete Dosage Forms

It has been found that the demands of a rapid-onset formulation are met surprisingly well by a preparation containing a solution or solution/suspension of the present invention encapsulated as a discrete dosage unit article. Therefore, another embodiment of the present invention is a concentrated composition, either a solution or solution/suspension, wherein the composition is formulated as a discrete dose unit or units, for example a soft or hard capsule. Suitable encapsulation material, for example, the gelatin or HPMC capsules, may be used.

Compositions of this embodiment are preferably formulated such that each discrete dosage unit contains about 0.3 ml to about 1.5 ml, more preferably about 0.3 ml to about 1 ml, for example about 0.8 ml or about 0.9 ml, of solution or solution/suspension.

Concentrated solutions or solutions/suspensions can be encapsulated by any method known in the art including the plate process, vacuum process, or the rotary die process. By the rotary die process, liquid encapsulation material, for example gelatin, flowing from an overhead tank is formed into two continuous ribbons by a rotary die machine and brought together by twin rotating dies. Simultaneously, metered fill material is injected between ribbons at the same moment that the dies form pockets of the ribbons. These pockets of fill-containing encapsulation material are then sealed by pressure and heat, and the capsules are served from the machine. Soft capsules may be manufactured in different shapes including round, oval, oblong, and tube-shape, among others. Additionally, by using two different ribbon colors, two-tone capsules can be produced.

Capsules that comprise HPMC are known in the art and can be prepared, sealed and/or coated, by way of non-limiting illustration, according to processes disclosed in the patents and publications listed below, each of which is individually incorporated herein by reference.
U.S. Pat. No. 4,250,997 to Bodenmann et al.
U.S. Pat. No. 5,264,223 to Yamamoto et al.
U.S. Pat. No. 5,756,123 to Yamamoto et al.
International Patent Publication No. WO 96/05812.
International Patent Publication No. WO 97/35537.
International Patent Publication No. WO 00/18377.
International Patent Publication No. WO 00/27367.
International Patent Publication No. WO 00/28976.
International Patent Publication No. WO 01/03676.
European Patent Application No. 0 211 079.
European Patent Application No. 0 919 228.
European Patent Application No. 1 029 539.
   Non-limiting illustrative examples of suitable HPMC-comprising capsules include XGel™ capsules of Bioprogress and Qualicaps™ of Shionogi.

This invention will be better understood from the examples, which follow. However, one skilled in the art will readily appreciate that the specific methods and results discussed are merely illustrative of the invention as described more fully in the claims, which follow thereafter.

### EXAMPLES

General Procedure for Preparing the Compositions of the Present Invention.

The dietary ingredient CoQ10 is placed in a container and the amount of sodium docusate is added when it is used. A lipid comprising ethyl oleate or ethyl ester of conjugated linoleic acid (ECLA)) is added and the cap is tightened. The container is put in a water bath at about 50° C. and shaken gently until all of the solid materials are dissolved. After the container is cooled to room temperature, appropriate amounts of polysorbate 80 and/or octanoic acid, or a mixture of mono-/di-glyceride (such as Captex 200) and other appropriate dietary ingredients are sequentially added into the container. The container is sealed and shaken gently until a clear solution is formed. The container is usually left at ambient conditions for future use.

### Example 1

Six CoQ10 solution formulations, SF-1 to SF-6, using ethyl oleate were prepared having components as shown in Table 1.

TABLE 1
Composition (mg/g) of CoQ10 solution formulations of
examples SF-1 to SF-6.

| Component | SF-1 | SF-2 | SF-3 | SF-4 | SF-5 | SF-6 |
|---|---|---|---|---|---|---|
| CoQ10 | 100 | 50 | 80 | 90 | 90 | 100 |
| Ethyl Oleate | 700 | — | — | 707 | 707 | 710 |
| Octanoic Acid | 47 | 700 | 50 | — | 50 | 43 |
| Oleic Acid | — | — | — | 50 | — | — |
| Sodium Docusate | — | — | 50 | — | 45 | 44 |
| Polysorbate 80 | 150 | 147 | 120 | 100 | 100 | 100 |
| BHA/BHT (1:1, | 2 | 2 | — | 2 | 2 | 2 |
| w/w) | | | | | | |
| Propyl Gallate | 1 | 1 | — | 1 | 1 | 1 |
| Capmul ® MCM | — | 100 | — | — | — | — |
| Captex ® 200 | — | — | 700 | — | — | — |
| Dimethylaminoethanol | — | — | — | 50 | — | — |
| Total = | 1000 | 1000 | 1000 | 1000 | 1000 | 1000 |

### Example 2

Six CoQ10 solution formulations, SF-7 to SF-12, using ECLA were prepared having components as shown in Table 2.

TABLE 2
Composition (mg/g) of CoQ10 solution formulations of
examples SF-7 to SF-12.

| | | | | | SF- | |
|---|---|---|---|---|---|---|
| Component | SF-7 | SF-8 | SF-9 | SF-10 | 11 | SF-12 |
| CoQ10 | 100 | 50 | 80 | 90 | 90 | 100 |
| Ethyl ester of | 747 | — | — | 757 | 707 | 710 |
| conjugated | | | | | | |
| linoleic acid | | | | | | |
| (ECLA) | | | | | | |
| Octanoic Acid | — | 700 | 50 | — | 50 | 43 |
| Oleic Acid | — | — | — | 50 | — | — |
| Sodium Docusate | — | — | 50 | — | 45 | 44 |
| Polysorbate 80 | 150 | 147 | 120 | 100 | 100 | 100 |
| BHA/BHT (1:1, | 2 | 2 | — | 2 | 2 | 2 |
| w/w) | | | | | | |
| Propyl Gallate | 1 | 1 | — | 1 | 1 | 1 |
| Captex ® 200 | — | 100 | — | — | — | — |
| Captex ® 100 | — | — | 700 | — | — | — |
| Total = | 1000 | 1000 | 1000 | 1000 | 1000 | 1000 |

### Example 3

Six lycopene solution formulations, SF-13 to SF-18, using either ethyl oleate or ECLA were prepared having components as shown in Table 3.

TABLE 3
Composition (mg/g) of lycopene solution formulations
of examples SF-13 to SF-18.

| | SF- | | | | SF- | |
|---|---|---|---|---|---|---|
| Component | 13 | SF-14 | SF-15 | SF-16 | 17 | SF-18 |
| Lycopene | 100 | 200 | 250 | 300 | 300 | 500 |
| Ethyl ester of | 500 | — | — | 597 | — | 300 |
| conjugated | | | | | | |
| linoleic acid | | | | | | |
| (ECLA) | | | | | | |
| Ethyl oleate | — | — | — | — | 597 | 97 |
| Sodium Docusate | 50 | — | 50 | — | — | — |
| Polysorbate 80 | 150 | 147 | 120 | 100 | 100 | 100 |
| BHA/BHT (1:1, | 2 | 2 | — | 2 | 2 | 2 |
| w/w) | | | | | | |
| Propyl Gallate | 1 | 1 | — | 1 | 1 | 1 |
| Captex ® 200 | — | 650 | — | — | — | — |
| Captex ® 100 | — | — | 580 | — | — | — |
| Total = | 1000 | 1000 | 1000 | 1000 | 1000 | 1000 |

### Example 4

Six beta-carotene solution formulations, SF-19 to SF-24, using either ethyl oleate or ECLA were prepared having components as shown in Table 4.

TABLE 4
Composition (mg/g) of beta-carotene solution
formulations of examples SF-19 to SF-24.

| | SF- | | | | SF- | |
|---|---|---|---|---|---|---|
| Component | 19 | SF-20 | SF-21 | SF-22 | 23 | SF-24 |
| beta-Carotene | 100 | 200 | 250 | 300 | 300 | 150 |
| Ethyl ester of | 500 | — | — | 597 | — | 300 |
| conjugated | | | | | | |
| linoleic acid | | | | | | |
| (ECLA) | | | | | | |
| Ethyl oleate | — | — | — | — | 597 | 347 |
| Sodium Docusate | 50 | — | 50 | — | — | — |
| Polysorbate 80 | 150 | 147 | 120 | 100 | 100 | 200 |
| BHA/BHT (1:1, | 2 | 2 | — | 2 | 2 | 2 |
| w/w) | | | | | | |
| Propyl Gallate | 1 | 1 | — | 1 | 1 | 1 |
| Captex ® 200 | — | 650 | — | — | — | — |
| Captex ® 100 | — | — | 580 | — | — | — |
| Total = | 1000 | 1000 | 1000 | 1000 | 1000 | 1000 |

### Example 5

Six solution formulations of combined dietary ingredients, SF-24 to SF-30, using either ethyl oleate or ECLA were prepared having components as shown in Table 5.

TABLE 5
Formulation composition (mg/g) containing multiple
dietary ingredients of examples SF-25 to SF-30.

| | SF- | | | | SF- | |
|---|---|---|---|---|---|---|
| Component | 25 | SF-26 | SF-27 | SF-28 | 29 | SF-30 |
| CoQ10 | 80 | 100 | 100 | 100 | 100 | 100 |
| beta-carotene | | — | — | 100 | — | — |
| Lecithin | 220 | | | | | |
| Lycopene | — | 100 | — | — | | — |
| Vitamin E | — | — | 200 | — | — | 200 |
| Lutein | — | — | — | — | 100 | — |
| Ethyl ester of | 597 | 697 | — | — | — | — |
| conjugated | | | | | | |
| linoleic acid | | | | | | |
| (ECLA) | | | | | | |
| Ethyl oleate | — | — | 597 | — | — | 300 |
| Polysorbate 80 | 100 | 100 | 100 | 100 | 100 | 100 |
| BHA/BHT (1:1, | 2 | 2 | 2 | 2 | 2 | 2 |
| w/w) | | | | | | |
| Propyl Gallate | 1 | 1 | 1 | 1 | 1 | 1 |
| Captex ® 200 | — | — | — | 697 | — | — |
| Captex ® 100 | — | — | — | — | 697 | 297 |
| Total = | 1000 | 1000 | 1000 | 1000 | 1000 | 1000 |

1. An orally deliverable dietary supplement composition comprising
(a) CoQ10
(b) a mixture consisting essentially of one or more monoesters of a long chain fatty acid having C6 to C24 carbon chain length and a short chain alcohol having C1 to C4 carbon chain length or one or more medium chain mono- and di-esters or a combination thereof; and
(c) one or more emulsifier,
wherein the whole amount of CoQ10 is in dissolved form and the other optional dietary ingredients are either completely dissolved or partially dissolved with particulates suspended and wherein the fatty acid esters and the emulsifiers are present in relative amounts such that the composition is self emulsifiable in the human biological fluids.

2. The composition of claim 1 may optionally contain other dietary ingredients selected from the group consisting of, Vitamin A, Vitamin D, Beta Carotene, Mixed Carotenoids Complex, Tocotrieniols, Tocopherols, or Vitamin E, Ascorbyl Palmitate, Soy Isoflavones, Lecithin, Lutein, Lycopene, Zeaxanthin, Beta-Cryptoxanthin, Resveratrol, Red Clover, and Saw Palmetto Lipid Extract.

3. The composition of claim 1 that comprises one or more dietary ingredients dose units each comprising about 1 mg to about 1000 mg of the dietary ingredients in combination.

4. The composition of claim 1 wherein the fatty acid monoester is chemically formed between a short chain, of C4 or less than, alcohol and a fatty acid.

5. The composition of claim 1 wherein the short chain alcohol component of the fatty acid monoester is ethanol or methanol.

6. The composition of claim 1 wherein the fatty acid component of the fatty acid monoester comprises a saturated or unsaturated C6 to C24 carbon chain.

7. The composition of claim 6 wherein the fatty acid is octanoic acid, caproic acid, caprylic acid, capric acid, lauric acid, myristic acid, palmitic acid, stearic acid, hydroxysteric acid, icosteric acid, elaidic acid, behenic acid, arachidic acid, palmitoleic acid, oleic acid, ricinoleic acid, conjugated and non-conjugated linoleic acid, conjugated and non-conjugated linolenic acid, eicosapentanenoic acid, erucic acid, and/or docosahexaenoic acid.

8. The composition of claim 6 wherein the fatty acid of the fatty acid monoester is oleic acid, conjugated linoleic acid and conjugated linolenic acid.

9. The composition of claim 1 wherein the monoesters are ethyl oleate, ethyl ester of conjugated linoleic acid, and ethyl ester of conjugated linolenic acid.

10. The composition of claim 1 wherein the medium chain mono- and di-esters are propylene glycol diesters, or medium chain mono-/di-glycerides Capmul® MCM or a combination thereof.

11. The composition of claim 10 wherein the propylene glycol diesters are Captex® 100 and Captex® 200.

12. The composition of claim 1 wherein the emulsifier is polysorbates, lecithin, Solutol, HS-15, Cremophor® EL or RH40, VE TPGS 1000, or sodium docusate.

13. The composition of claim 12 wherein the plysorbate is Polysorbate 20, 60, 65, and 80.

14. The composition of claim 1, wherein the emulsifier is polysorbate 80 or lecithin.

15. The composition of claim 1 wherein the emulsifier is polysorbate 80 in an amount of about 1% to about 50% weight per weight of the liquid vehicle, in an amount of about 5% to about 35%, or 5 about to about 20%.

16. The composition of claim 1 further comprising optionally an additional emulsifier.

17. The composition of claim 15, wherein the additional emulsifier is lecithin in an amount of about 1% to about 50% weight per weight of the liquid vehicle, in an amount of about 10% to about 40%, or in about 15 to about 30%.

18. The composition of claim 1 wherein the fatty acid ester and the emulsifiers are collectively present in an amount of about 10% to about 95%, by weight of the composition.

19. The composition of claim 1 wherein the solvent liquid further comprises one or more nutraceutically acceptable excipients selected from sweeteners, antioxidants, preservatives, flavoring agents, colorants and thickeners.

20. The composition of claim 1 wherein CoQ10 in the composition is in dissolved form, and the composition further optionally comprises one or more other dietary ingredients that may not be completely dissolved with particulates dispersed in the composition.

21. The composition of claim 19, wherein said CoQ10 comprises at least about 5% by weight of the composition.

22. The composition of claim 1 that is an unencapsulated imbibable liquid.

23-55. (canceled)
